(19) United States
(12) Patent Application Publication
(10) Pub. No.: US 2024/0226936 A1
(43) Pub. Date: Jul. 11, 2024

(54) FLUID PRODUCT DISPENSER

(71) Applicant: APTAR FRANCE SAS, LE NEUBOURG (FR)

(72) Inventors: Fabrice PERIGNON, LA CHAPELLE FORTIN (FR); Christophe TONDENIER, BELBEUF (FR)

(73) Assignee: APTAR FRANCE SAS, LE NEUBOURG (JP)

(21) Appl. No.: 18/289,080

(22) PCT Filed: May 9, 2022
(86) PCT No.: PCT/FR2022/050884

§ 371 Date: Oct. 31, 2023

(30) Foreign Application Priority Data
May 10, 2021 (FR) FR2104921

(51) Int. Cl. B05B 11/00; B05B 11/10

(52) U.S. Cl. CPC B05B 11/0038; B05B 11/0054; B05B 11/1067

(57) ABSTRACT

A fluid product dispenser having a fluid product reservoir (R) having a neck (R3), and an assembly (E) having a dispensing member (P), such as a pump or a valve, the dispenser having at least one cam track (22) and at least one lug (41) designed to follow the cam track (22) and a spring (5) for urging the lug (41) out of the cam track (22), the cam track (22) being integral with one of the fluid product reservoir (R) and the assembly (E) and the lug being integral with the other of the fluid product reservoir (R) and the assembly (E). One of the cam track (22) and the lug (41) is formed by a rotary member (4).

The present invention relates to a refill fluid product dispenser, which can be used in the fields of perfumery, cosmetics or also pharmacy, to dispense various fluid products such as perfume, creams, lotions, etc.

In the prior art, dispensers are already known, the fluid product reservoir of which is presented in the form of a refill or of a cartridge, which is removably connected to an assembly comprising a dispensing member, such as a pump or a valve. Thus, the reservoir, once empty, can be replaced by a full reservoir. To enable the reservoir connection/disconnection, snap-fitted- or screwed-type connection means are frequently used. This involves the reservoir being able to be held sufficiently firmly to unscrew it or unsnap it. For this, it is necessary that at least one significant part of the reservoir remains accessible, and therefore visible, which can damage the overall appearance of the dispenser.

Document EP2916964 makes it possible to overcome this disadvantage with a removable connection system of the retractable tip pen-type, enabling the connection and the disconnection by quite simply pressing on the bottom of the reservoir. A first press followed by a release brings the reservoir into the sealed assembled position and another press followed by a release enables the reservoir to be ejected, so as to be able to then remove it completely. A cam system associated with a spring makes it possible to generate these successive operations by a single axial press on the reservoir.

The reservoir is received in a sliding crown, which is itself received in a rotary ring. The connection system is complicated, because it is fully integrated with the assembly: the reservoir being simply received in the crown by friction, or optionally with a slight snap-fitting. There is no locked connection between the reservoir and the assembly. The connection system of the assembly only serves to extract the reservoir from the case, but not to retain it inside. An accidental extraction of the reservoir is possible.

Document U.S. Ser. No. 10/835,014 describes a dispenser comprising a reservoir with a neck with at least one cam track, and an assembly comprising a dispensing member, such as a pump or a valve, with at least one lug designed to follow the cam track. A spring being provided for urging the lug out of the cam track.

The disadvantage with this dispenser is that the reservoir is rotated, because the lug is constrained to follow the cam track. Consequently, the gripping of the reservoir by the user opposes or impedes the rotation of the reservoir.

The present invention aims to overcome this disadvantage of the prior art, by proposing a fluid product dispenser comprising:
a fluid product reservoir comprising a neck, and
an assembly comprising a dispensing member, such as a pump or a valve, the dispenser comprising at least one cam track and at least one lug designed to follow the cam track, and a spring for urging the lug out of the cam track, the cam track being integral with one of the fluid product reservoir and the assembly, and the lug being integral with the other of the fluid product reservoir and the assembly, characterised in that one of the cam track and the lug is formed by a rotary member.

Thus, even if the user grasps the reservoir so as to block it in rotation, the lug can all the same, follow its cam track, since it is the lug or the cam track which rotates. Thus, the reservoir undergoes no rotation out of the traveling of the lug in the cam track. This provides a feeling of stability and of quality to the user, who does not perceive even the operation of the removable connection.

According to a first embodiment of the invention, the rotary member is a rotary socket, the assembly forming said at least one lug, said at least one cam track is formed by a ring fixedly mounted on the neck of the reservoir. Advantageously, the assembly comprises a casing, wherein the rotary socket is axially retained.

According to a second embodiment of the invention, the rotary member is a rotary ring of the reservoir forming the cam track, the lug being formed by a shell of the assembly. Advantageously, the rotary ring is rotatably mounted around the neck of the reservoir.

Two other embodiments are also possible:
Rotary lug formed by the reservoir, and
Rotary cam track formed by the assembly.

In any case, the cam track can comprise:
a locking housing, wherein the lug is urged by the spring in the connection position,
a first and a second low abutment on either side of the locking housing, and
a first and a second cam surface, over which the lug slides under the action of an axial thrust against the spring, the first cam surface driving the lug to the first low abutment, the release of the axial pressure thus bringing the lug into the locking housing, another axial pressure bringing the lug to slide over the second cam surface to the second low abutment and another release of pressure bringing the lug to be released from the cam track under the action of the spring.

Preferably, the dispenser further comprises at least one ramp for driving the lug to the cam track. This ramp is formed by the element which forms the cam track. This ramp makes it possible for the user to not have to search, by trail and error, the angular position of the inlet of the cam track. The lug slides over the ramp which ends at the inlet of the cam track.

According to another aspect of the invention, the assembly can comprise a case provided with an insertion/extraction opening and defining an insertion/extraction axis X, the fluid product reservoir being engaged in the case through the insertion/extraction opening, the reservoir comprising an accessible bottom at the insertion/extraction opening to exert an axial thrust on the reservoir against the spring.

According to another interesting feature of the invention, the neck of the reservoir defines an opening and an upper annular edge, the reservoir being provided with a blocking member which seals the opening of the neck, the blocking member comprising a pierceable membrane which is disposed inside the neck axially away from the upper annular edge. Moreover, the assembly can comprise piercing means forming a piercing tip at the lower end of a sheath in which the dispensing member is received.

Advantageously, the blocking member can comprise a sleeve which extends into the neck from the upper annular edge, the pierceable membrane being connected to a lower end of the sleeve, the sheath advantageously coming into sealed annular radial contact with the sleeve.

Advantageously, the neck projects from a shoulder, the pierceable membrane being positioned substantially at this shoulder, with the sleeve extending substantially over the entire height of the neck.

In the scope of the first embodiment of the invention, the blocking member can comprise an annular collar which rests on the upper annular edge, the sleeve being connected to the annular collar, the reservoir further comprising a ring which engages with the annular collar to press on the upper annular edge, the ring forming the cam track.

In the scope of the second embodiment of the invention, the blocking member can comprise an external skirt which is engaged around the neck of the reservoir, the rotary ring which forms the cam track being rotatably mounted on the external skirt.

The spirit of the invention resides in the fact of producing a pen-type connection which does not induce rotation of the reservoir, such that it can be moved without rotating in the assembly.

The invention now be more fully described in reference to the accompanying drawings, giving as a non-limiting example, an embodiment of the invention.

In the figures:

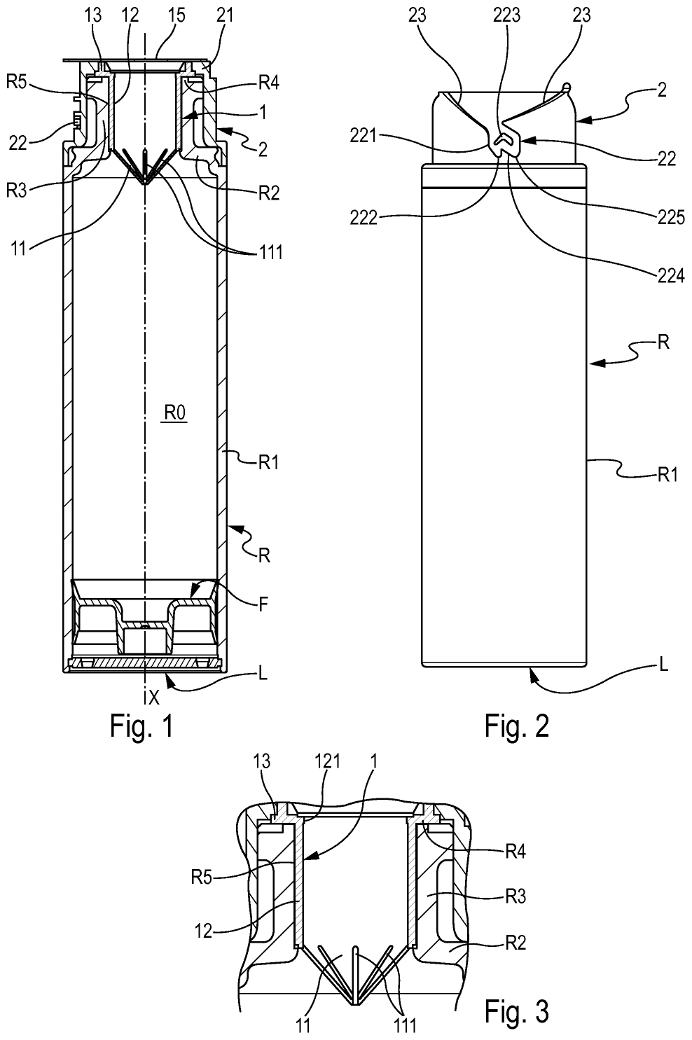

FIG. 1 is a vertical cross-sectional view through the reservoir of a fluid product dispenser according to the invention,

FIG. 2 is a front view of the reservoir of FIG. 1,

FIG. 3 is an enlarged view of a detail of FIG. 1,

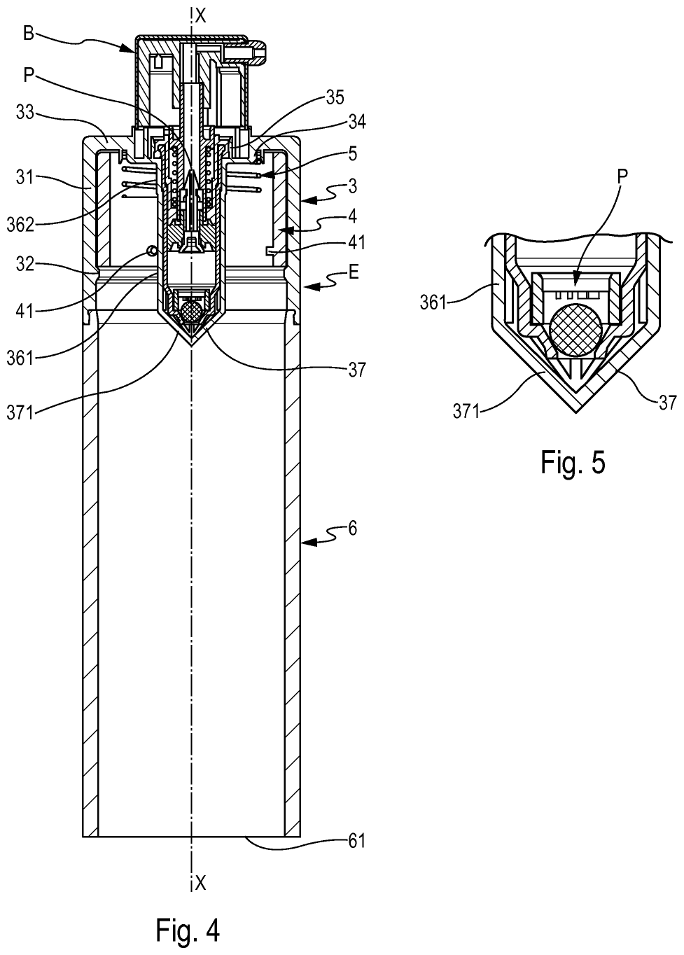

FIG. 4 is a vertical cross-sectional view through the assembly of a fluid product dispenser according to the invention, intended to be associated with the reservoir of FIG. 1,

FIG. 5 is an enlarged view of a detail of FIG. 4,

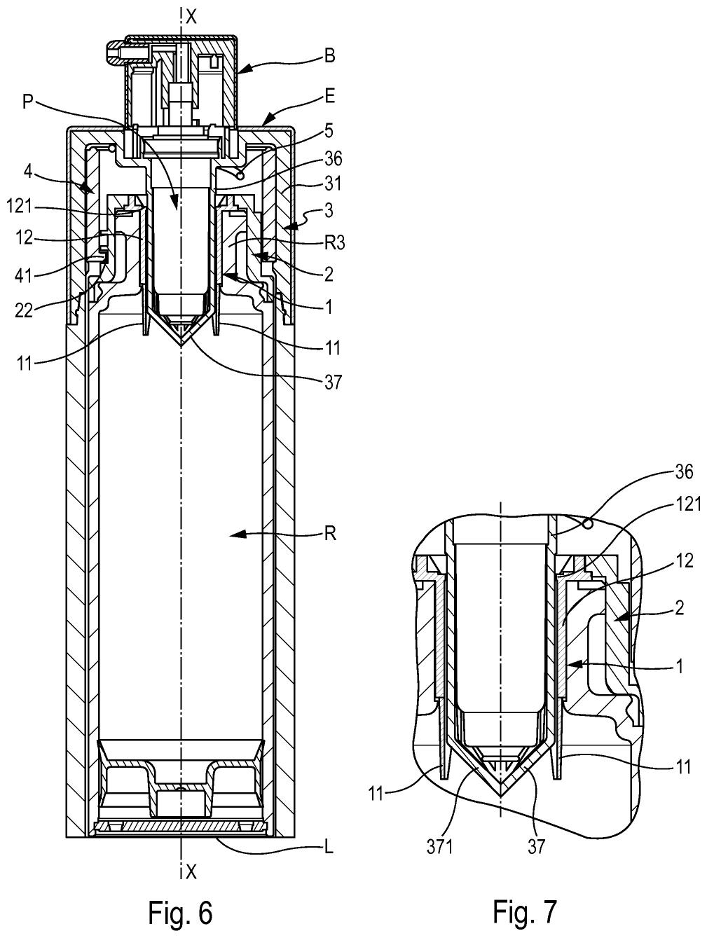

FIG. 6 is a vertical cross-sectional view through the fluid product dispenser resulting from the association of the reservoir and of the assembly according to the invention,

FIG. 7 is an enlarged view of a detail of FIG. 6,

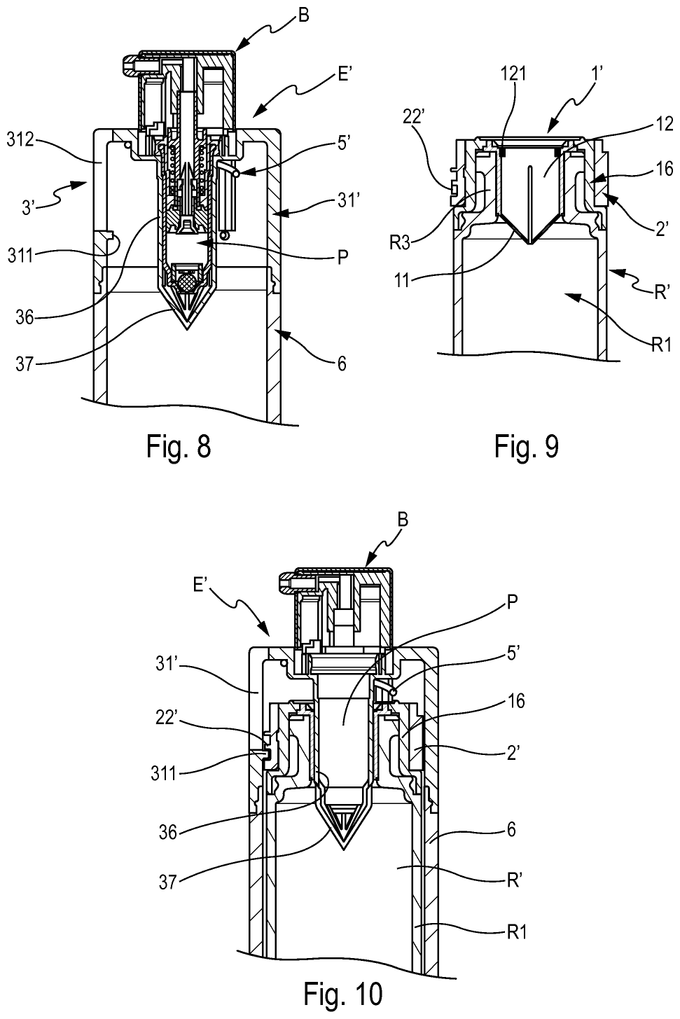

FIG. 8 is a view similar to that of FIG. 4 for a second embodiment of the invention,

FIG. 9 is a view similar to that of FIG. 1 for a second embodiment of the invention, and

FIG. 10 is a view similar to that of FIG. 6 for a second embodiment of the invention.

The dispenser of the invention comprises an assembly E integrating a dispensing member P and a reservoir R containing a fluid product. The reservoir R is connected to the assembly E removably or definitively.

Now, reference will be made to FIGS. 1 to 3 to describe, in a detailed manner, the fluid product reservoir R. It comprises a container R0 intended to contain the fluid product, which can be a cream, a gel, a lotion, a serum, a perfume, etc. This container R0 comprises a cylindrical drum R1, wherein a follower piston F slides. Instead of the follower piston F, a flexible pocket can also be used. The lower end of the drum R1 is advantageously blocked by a bottom L. At its opposite end, the drum R1 is connected to a shoulder R2, which itself is extended by a neck R3 which projects upwards. This neck R3 forms an upper annular edge R4 and internally defines an opening R5, which makes the container R0 communicate with the outside. This is a conventional design for a fluid product reservoir.

According to the invention, the reservoir R is further provided with a blocking member 1 which sealingly seals the opening R5. This blocking member 1 comprises a pierceable membrane 11, which can be provided with tear lines 111 of a lesser thickness. This membrane 11 has, in this case, a conic shape with the tip oriented downwards, i.e. towards the follower piston F. The membrane 11 can have another shape, in particular flat. It can be noted that the membrane extends to the shoulder R2, to the lower end of the neck R3, and therefore axially away from the upper annular edge R4.

The blocking member 1 also comprises a sleeve 12 which can be cylindrical. This sleeve 12 extends over at least some of the height of the neck R3, and preferably almost over all of the height of the neck R3. The sleeve 12 can come into sealed contact with the internal wall of the neck R3 which defines the opening R5. The pierceable membrane 11 is connected to the sleeve at its lower annular edge. It can be noted that the sleeve 12 has a wall thickness greater than that of the pierceable membrane 11. It can be said that the sleeve 12 serves as a support for the membrane 11, so as to position it at the shoulder R2, so as to together constitute the roof of the container R0, opposite the follower piston F.

The blocking member 1 also comprises an annular collar 13 which rests on the upper annular edge R4. This collar 13 projects radially outwards from the upper end of the sleeve 12. It can be noted in FIG. 3 that an annular sealing ridge 121 is formed on the internal wall of the sleeve 12 at the collar 13. It can also be said that the collar 13 internally forms the annular sealing ridge 121. Its function will be given below. This ridge 121 could be located elsewhere over the height of the sleeve 12.

Optionally, the blocking member 1 can be provided with a lid 15 fixed on the collar 13 or on the upper end of the sleeve 12. This lid 15 is removable or pierceable.

This blocking member 1 makes it possible to seal the reservoir R inside the neck R3, such that there is no or practically no air in the reservoir. Indeed, the reservoir can be filled with fluid product around up to its shoulder R2 or a little below it. The blocking member 1 is then inserted into the neck R3 while letting air escape. Its pierceable membrane thus comes into the proximity of or even in contact with the fluid product, no longer leaving or only leaving a small amount of air in the reservoir R. In addition, thanks to its depressed positioning, the membrane 11 is protected against an accidental piercing.

The reservoir also comprises a ring 2, which is mounted on the neck R3 so as to surround it. The fixing of the ring 2 on the neck R3 can be done by any means, such as snap-fitting, forcibly mounting, screwing, bonding, welding, etc. The fixing can be removable or definitive. The ring can come into contact with the shoulder. The ring comprises a rest flange 21 which projects radially inwards. This flange 21 comes into contact with the collar 13 of the blocking member 1, so as to compress it on the upper annular edge R4 of the neck R3. It can be said that the ring 2 makes it possible to lock the blocking member 1 on the neck R3.

According to the invention, the ring 2 externally forms connection means intended to engage with the assembly E to connect the reservoir R to the assembly E. Advantageously, these are removable connection means, making it possible to remove the reservoir R from the assembly E. These connection means can comprise at least one cam track 22. In FIG. 3, it can be understood that there are three cam tracks 22 on the ring 2. Each cam track 22 comprises a locking housing 223, a first low abutment 222, a second low abutment 225 on either side of the locking housing 223, a first cam surface 221 and a second cam surface 224. The tracking of a lug through this cam track is as follows: first cam surface 221, first low abutment 222, locking housing 223, second cam surface 224, second low abutment 225, then the outlet of the cam track 22.

In order to bring the lug into a cam track from any angular orientation, the ring 2 advantageously forms ramps 23 which converge towards the cam tracks 22.

It must be noted that a reservoir with blocking member 1, but without cam track 22 can be considered, just like a reservoir with cam track 22, but without blocking member 1. Preferably, the reservoir R comprises both a blocking member and at least one cam track 22.

Now, reference will be made to FIGS. 4 and 5 to describe the assembly E in a detailed manner.

The dispensing member P of the assembly E can be a pump or a valve, which is provided with a pushbutton B to actuate it and thus dispense the fluid product. The dispensing member P is not critical for the invention and will therefore not be described in detail. When this is a pump, this conventionally comprises a pump body with a fluid product inlet. A piston sealingly slides into the pump body to pressurise a dose of fluid product. The piston is mounted on an actuation rod which is moved back and forth against a return spring. The dose of pressurised fluid product escapes through an outlet valve towards the pushbutton B which comprises a fluid product outlet. This design is absolutely conventional for a pump in the fields of cosmetics, perfumery or pharmacy.

The assembly E comprises a casing 3 forming an external shell 31, which is cylindrical. The shell 31 internally forms a retaining ridge 31 and at its upper end, an annular plate 33. A socket 4 is received between the retaining ridge 31 and the plate 33, so as to be axially blocked, while being rotatably free on itself. This rotary socket 4 forms at least one cam lug 41, and preferably three, on its inner wall. These cam lugs 41 are located in the proximity of the lower edge of the socket 4. The casing 3 also forms an anchoring profile 34 for a spring 5 which extends freely downwards inside the socket 4. The casing also comprises receiving means 35 for the dispensing member P.

Advantageously, the casing 3 further comprises a sheath 36 which extends freely downwards inside the shell 31, the socket 4 and the spring 5. This sheath 36 forms, at its lower end, a piercing tip 37, designed to pierce the membrane 11 of the reservoir R, as can be seen below. The tip 37 comprises at least one opening 371, which can be seen in FIG. 5, which communicates directly with the inlet of the dispensing member P. The tip 37 can have a conic shape. The sheath can form a lower section 361 of small diameter and an upper section 362 of greater diameter. The main part of the dispensing member P is housed in the sheath 36 and occupies almost all of the volume of the sheath. The external wall of the dispensing member P can optionally come into contact with the internal wall of the sheath 36.

The assembly E also comprises a case 6 which is connected to the lower end of the shell 31. The case 6 could be made of one piece with the shell 31. This case 6 defines an insertion/extraction opening 61 and an insertion/extraction axis X.

According to the invention, the reservoir R is connected to the assembly E as follows. The reservoir R is inserted into the case 6 through its opening 61 with the neck R3 at the top. The axial insertion is continued until the piercing tip 37 abuts against the pierceable membrane 11. The lid 15 has been previously removed or pierced by the tip 37. A sufficient axial pressure enables the tip 37 to break the membrane 11, preferably at its tear lines 111. The axial insertion can thus be continued until the cam lugs 41 come into contact with the ring 2. This axial insertion is done against the spring 5. In most cases, the lugs 41 will come into contact with the ramps 23. From this moment, an axial pressure on the reservoir R will rotate the socket 4 in the shell 31. The lugs 41 will slide over the ramps 23 to reach the inlets of the cam tracks 22. From there, each lug 41 will follow the following tracking. The lug 41 slides under the action of an axial thrust against the spring 5 on the first cam surface 221 which drives it to the first low abutment 222. A release of the axial pressure thus brings the lug 41 into the locking housing 223 under the action of the spring 5. The reservoir is thus connected to the assembly E. The sealing between the reservoir R and the casing 3 is ensured by the annular radial contact of the upper section 362 of the sheath against the sealing ridge 121 of the blocking member 1. The user can thus use the dispenser by actuating the pushbutton B using a finger. Fluid product coming from the reservoir R is thus dispensed by the dispensing member P.

When the reservoir R is empty, an axial pressure on the reservoir R extracts the lug 41 from the locking housing 123 and brings it to slide over the second cam surface 224 to the second low abutment 225. A release of the pressure thus brings the lug 41 to be released from the cam track 22 under the action of the spring 5. The reservoir R can thus be freely extracted from the case 6. Another reservoir R can thus be put in place in the assembly E in the manner described above.

It must be noted that the rotary socket 4 makes it possible to connect the reservoir R in the assembly E without rotating it, since it is the socket which rotates on itself. This provides a more pleasant feeling and completely conceals the operation of the connection.

It can also be noted that an assembly E with tip 37, but without connection system (socket 4 and spring 5), can be associated with a reservoir R with blocking member 1, but without cam track 22. Likewise, an assembly E with connection system (socket 4 and spring 5), but without tip 37, can be associated with a reservoir R with cam tracks 22, but without blocking member 1. In addition, an assembly E with connection system (socket 4 and spring 5), but without tip 37, can be associated with a reservoir R with cam tracks 22 and blocking member 1. And also, an assembly E with tip 37, but without connection system (socket 4 and spring 5), can be associated with a reservoir R with blocking member 1, but without cam track 22: the connection between the reservoir and the assembly thus being made by any known connection means, like for example snap-fitting, screwing, bayonet, etc.

By referring to FIGS. 8 to 10, a second embodiment of the invention is seen, which differs from the first, in that the cam tracks of this second embodiment are formed by a rotary member, while they are fixed in the first embodiment, where the lugs are formed by a rotary member, namely the rotary socket 4.

In FIG. 8, the assembly E′ comprises a casing 3′ having an external shell 31′ to which the case 6 is connected. The external shell 31′ internally forms three lugs 311, which are therefore fixed. Optionally, the shell 31′ comprises a side window 312. The sheath 36 with its tip 37 are made of one piece with the shell 31′. The assembly E′ also comprises a spring 5′.

In FIG. 9, the neck R3 of the reservoir R′ is surrounded by an external skirt 16, which is advantageously made of one piece with the sleeve 12 and the membrane 11 of the blocking member 1′. This external skirt 16 is therefore fixedly mounted on the neck R3. It is surrounded by a ring 2′, which is rotatably mounted on the skirt 16. The ring 2′ can therefore freely rotated on itself around the skirt 16, which is fixedly mounted around the neck R3. The rotary ring 2′ externally forms three cam tracks 22′, which are identical or similar to those of the first embodiment. The ring 2′ can also form ramps, identical or similar to the ramps 23.

In FIG. 10, the reservoir R′ is in place inside the assembly E′. The tip 37 has pierced the membrane 11 and the lugs 311 are engaged with the cam tracks 22′, in the same way as in the first embodiment. During the connection, the ring 2′ rotates around the skirt 16, such that the drum R1 can remain rotatably static.

This second embodiment therefore consists of moving the rotary element of the assembly E on the reservoir R′, while holding the lugs on the assembly and the cam tracks on the reservoir. Without moving away from the scope of the invention, it is also possible to form the lugs on the reservoir and the cam tracks on the assembly. Consequently, there are four possible embodiments:
Rotary lugs formed by the assembly (1st embodiment),
Rotary cam tracks formed by the reservoir (2nd embodiment),
Rotary lugs formed by the reservoir, and
Rotary cam tracks formed by the assembly.

1. a fluid product dispenser comprising:
a fluid product reservoir comprising a neck, and
an assembly comprising a dispensing member, such as a pump or a valve, the dispenser comprising at least one cam track and at least one lug designed to follow the cam track and a spring for urging the lug out of the cam track, the cam track being integral with one of the fluid product reservoir and the assembly and the lug being integral with the other of the fluid product reservoir and the assembly,
wherein one of the cam track and the lug is formed by a rotary member.

2. The fluid product dispenser according to claim 1, wherein the rotary member is a rotary socket, the assembly forming said at least one lug, said at least one cam track is formed by a ring, fixedly mounted on the neck of the reservoir.

3. The fluid product dispenser according to claim 2, wherein the assembly comprises a casing, wherein the rotary socket is axially retained.

4. The fluid product dispenser according to claim 1, wherein the rotary member is a rotary ring of the reservoir forming the cam track, the lug being formed by a shell of the assembly.

5. The fluid product dispenser according to claim 1, wherein the rotary ring is rotatably mounted around the neck of the reservoir.

6. The fluid product dispenser according to claim 1, wherein the cam track comprises:
a locking housing, wherein the lug is urged by the spring in the connection position,
a first and a second low abutment on either side of the locking housing, and
a first and a second cam surface over which the lug slides under the action of an axial thrust against the spring, the first cam surface driving the lug to the first low abutment, the release of the axial pressure thus bringing the lug into the locking housing, another axial pressure bringing the lug to slide over the second cam surface to the second low abutment and another release of the pressure bringing the lug to be released from the cam track under the action of the spring.

7. The fluid product dispenser according to claim 1, further comprising at least one ramp to drive the lug to the cam track.

8. The fluid product dispenser according to claim 1, wherein the assembly comprises a case provided with an insertion/extraction opening and defining an insertion/extraction axis X, the fluid product reservoir being engaged in the case through the insertion/extraction opening, the reservoir comprising a bottom accessible at the insertion/extraction opening to exert an axial thrust on the reservoir against the spring.

9. The fluid product dispenser according to claim 1, wherein
the neck of the reservoir defines an opening and an upper annular edge, the reservoir being provided with a blocking member which seals the opening of the neck, the blocking member comprising a pierceable membrane which is disposed inside the neck,
the assembly comprises piercing means forming a piercing tip at the lower end of a sheath in which the dispensing member is received.

10. The fluid product dispenser according to claim 9, wherein the blocking member comprises a sleeve which extends into the neck from the upper annular edge, the pierceable membrane being connected to a lower end of the sleeve, the sheath advantageously coming into sealed annular radial contact with the sleeve.

11. The fluid product dispenser according to claim 10, wherein the neck projects from a shoulder, the pierceable membrane being positioned substantially at this shoulder, with the sleeve extending substantially over the entire height of the neck.

12. The fluid product dispenser according to claim 11, wherein the blocking member comprises an annular collar which rests on the upper annular edge, the sleeve being connected to the annular collar, the reservoir further comprising a ring which engages with the annular collar to press it on the upper annular edge, the ring forming the cam track.

13. The fluid product dispenser according to claim 11, wherein the blocking member comprises an external skirt which is engaged around the neck of the reservoir, the rotary ring which forms the cam track being rotatably mounted on the external skirt.
